(19) United States
(12) Patent Application Publication
(10) Pub. No.: US 2024/0045956 A1
(43) Pub. Date: Feb. 8, 2024

(54) MALICIOUS SOURCE CODE DETECTION

(71) Applicant: B.G. Negev Technologies and Applications Ltd., Beer Sheva (IL)

(72) Inventors: Michael Fire, Omer (IL); Chen Tsfaty, Beer Sheva (IL)

(73) Assignee: B.G. Negev Technologies and Applications Ltd., Beer Sheva (IL)

(21) Appl. No.: 18/364,461

(22) Filed: Aug. 2, 2023

Related U.S. Application Data
(60) Provisional application No. 63/395,880, filed on Aug. 8, 2022.

(51) Int. Cl. G06F 21/56; G06F 8/41

(52) U.S. Cl. CPC G06F 21/563; G06F 8/42; G06F 2221/033

(57) ABSTRACT

A method for malicious source code detection, the method includes (a) obtaining, by a processing circuit, an embedding of a source code for a function; (b) applying, by the processing circuit, an anomaly detection process on the embedding of the source code; and (c) concluding, by the processing circuit, that the source code comprises a malicious code when the anomaly detection process indicates that the embedding of the source code is an outlier.

### CROSS REFERENCE

This application claims priority from U.S. provisional patent 63/395,880 filing date 8/8/2022 which is incorporated herein by reference in its entirety.

### BACKGROUND

Code poising aims to access source code, build processes, or update mechanisms by infecting legitimate apps to distribute malware. Hence, the end-users will perceive that malware as safe and trustworthy software and will therefore be more likely to download it. An illustrative example is the Codecov attack, where a backdoor concealed within a Codecov uploader script was widely downloaded. In April 2021, attackers compromised a Codecov server to inject malicious code into a bash uploader script. Codecov customers then downloaded this script for two months. When executed, the script exfiltrated sensitive information, including keys, tokens, and credentials from those customers' Continuous Integration/Continuous Delivery (CI/CD) environments. Using these data, Codecov attackers reportedly breached hundreds of customer networks, including HashiCorp, Twilio, Rapid7, Monday.com, and e-commerce giant Mercari.

These types of attacks are becoming increasingly popular and harmful due, in part, to modern development procedures that use open source packages and public repositories. These procedures are efficient, cost-effective and accelerate development, and therefore popular among many developers. There has been a 73% growth of open-source software component downloads in 2021 compared to 2020, and a reported 77% increase in the use of open-source software between 2021 to 2022 among various companies.

Additionally, Red-Hat predicts an 8% decline in the use of proprietary software in software already in use in respondents' organizations over the next two years. Over the same period, they expect enterprise open source to increase by 5% and community-based open-source also increasing by 3% over the same period, resulting in open-source technologies being adopted more than any other technology. Development procedures, involving those packages and repositories are mostly automatic, or at least semi-automatic, the same as developers installing an open-source package.

As a result of this growth, popular packages, development communities, lead contributors, and many more can be considered attractive targets for software supply chain attacks. These kinds of attacks can make dependent software projects more vulnerable. In 2021, OWASP considered software supply chain threats to be one of the Top-10 security issues worldwide. A lead example of such an attacks was the ua-parser-js attack, where in October 2021 the attacker was granted ownership of the package by account takeover and published three malicious versions. At that time, ua-parser-js was a highly popular package with more than seven million weekly downloads. Logic bombs also pose a threat—see https://www.csoonline.com/article/510947/logic-bomb.html.

In recent years, a vast research field has emerged to deal with this threat. This field is researched by academia and is part of the application security market, which has been valued at 6.2 billion USD. This research field includes many aspects that depend on various parameters, such as programming language (PL). Different PLs have different security issues. For example, Python has assert statements that control the application logic or program execution, which can lead to the retrieval of incorrect results, introduce security risks, or cause program failure. In CPP, it is more common to commit buffer overruns by writing input to smaller buffers. A second important parameter to consider is the scope of the functionalities being examined (function, class, scripts, etc.). For example, there are attacks targeting central locations in the package, e.g., the installation phase or fundamental functions.

### BRIEF DESCRIPTION OF THE DRAWINGS

The subject matter regarded as the embodiments of the disclosure is particularly pointed out and distinctly claimed in the concluding portion of the specification. The embodiments of the disclosure, however, both as to organization and method of operation, together with objects, features, and advantages thereof, may best be understood by reference to the following detailed description when read with the accompanying drawings in which:

FIG. 1 is an example of malicious source code detection (MSDT);

FIG. 2 is an example of an abstract syntax tree (AST) transformation of a code snippet if x++3: print (“Hello”);

FIG. 3 illustrates an example of a numbers of different implementations (y-axis) for different functions (x-axis); and

FIGS. 4A-4C illustrate examples of different DB scan parameters tuning process—especially with an increasing number of samples—minimum 2 samples, minimum 5 samples and minimum 10 samples; example of a method;

FIGS. 5A-4D illustrate examples of MSDT_{DBSCAN} and MSDT_{Ecod} of various functions;

FIG. 6 illustrates examples of MSDT_{DBSCAN} to MSDT_{Ecod} for different functions;

FIG. 7 illustrates an example of a principle component analysis (PCA) of a real case detection;

FIG. 8 illustrates an example of a PCA of a benign get function and of a malicious get function;

FIG. 9 illustrates an example of a PCA of a benign log function and of a malicious get function; and

FIG. 10 illustrates an example of a method.

### DETAILED DESCRIPTION OF THE DRAWINGS

Any reference to “may be” should also refer to “may not be”.

In the following detailed description, numerous specific details are set forth in order to provide a thorough understanding of the one or more embodiments of the disclosure. However, it will be understood by those skilled in the art that the present one or more embodiments of the disclosure may be practiced without these specific details. In other instances, well-known methods, procedures, and components have not been described in detail so as not to obscure the present one or more embodiments of the disclosure.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the disclosure may for the most part, be implemented using electronic components and circuits known to those skilled in the art, details will not be explained in any greater extent than that considered necessary as illustrated above, for the understanding and appreciation of the underlying concepts of the present one or more embodiments of the disclosure and in order not to obfuscate or distract from the teachings of the present one or more embodiments of the disclosure.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system and any other component should be applied mutatis mutandis to a method that may be executed by a system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Any combination of any module or unit listed in any of the figures, any part of the specification and/or any claims may be provided. Especially any combination of any claimed feature may be provided.

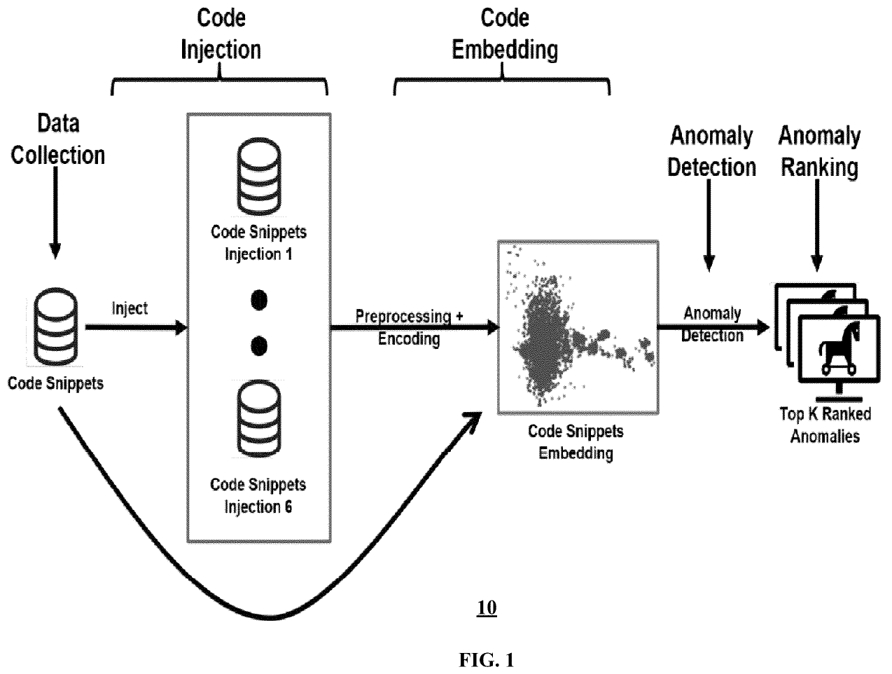

There is provided a MSDT algorithm for detecting malicious code injection within the functions' source code, by static analysis. FIG. 1 illustrates an example 10 of MSDT.

Firstly, the inventors used the PY150 dataset to train a deep neural architecture model.

Secondly, by utilizing that model, the inventors were able to embed every function in the CodeSearchNet (CSN) Python dataset, which is used for experimental evaluation, into the representation space of the model's encoding part.

Thirdly, the inventors applied a clustering algorithm over every function type implementation to detect anomalies by outlier research. Lastly, the inventors ranked the anomalies by their distance from the nearest clusters' border points—the farther the point is, the higher the score.

The inventors conducted extensive experiments to evaluate MSDT's performance. The inventors started by randomly injecting five different real-world malicious codes into the top 100 common functions, using Code2Seq as the deep neural model and DBSCAN for the clustering algorithm.

Next, the inventors measured the precision at k (precision@k) (for various k values) of MSDT's ability to match functions classified as malicious with their proper tagging (see the Experiments section). The precision@k test result values were as high as 0.909. For example, MSDT achieved this result when k=20 for the different implementations of the get function. These implementations were randomly injected as part of a real-world attack.

Additionally, the inventors empirically evaluated MSDT on a real-world attack and succeeded in detecting it. Lastly, the inventors empirically compared MSDT against widely used static analysis tools, which can only work on files. As MSDT works on functions, it has a more precise capability to detect an injection in a given function.

In addition to the MSDT algorithm itself, the inventors also described and shared theirs open, curated dataset of 607,461 functions, some of which were injected with several real-world malicious codes in this work. This dataset can be used in future works within the field of code injection detection.

In recent years, the awareness of the threats regarding public repositories and open-source packages has increased. As a result, many studies point out two main security issues with the usage of those packages: (1) vulnerable packages and (2) malicious intent in packages. Vulnerable packages contain a flaw in their design, unhandled code error or other bad practices that could be a future security risk. Communities and commercial companies have vastly researched this widespread threat (e.g., Snyk and Mend). Usually, this threat is based on Common Vulnerabilities and Exposures (CVEs). Those vulnerabilities allow the malicious actor, with prior knowledge of the package usage location, to achieve its goal with a few actions. Malicious intent in packages contain bad design, unhandled code error, or a code that does not serve the main functionality of the program, etc. Those examples are created to be exploited or triggered during some phases of the package (installation, test, runtime, etc.).

Studies have shown a rise in malicious functionalities appearing in public repositories and highly used packages. These studies have shown that there are common injection methods for malicious actors to infect packages. As Ohm et al. (Marc Ohm, Henrik Plate, Arnold Sykosch, Michael Meier “Backstabbers knife collection: A review of open Source supply Chain attack” International Conference on Detection of Intrusions and Malware, and Vulnerability Assessment, pages 23-24, Springer 2020) demonstrated, to inject malicious code into a package, an attacker may either infect an existing package or create a new one similar to the original one (which is often called dependency confusion.)

A new malicious package developed and published by a malicious actor has to follow several principles: (1) for a proper replacement to be made to the targeted package, it has to contain a proper replacement to the targeted package, it has to contain a semi-ident functionality; and (2) it has to be attractive, ending up in the targeted users' dependency tree. To grant the use of the new package types, one of the following methods can be employed: naming the malicious package in a similar manner to the original one (typosquatting), creating a trojan in the package, using an unmaintained package, or user account (use after free).

The second injection strategy can infect existing packages through one of the following methods: (1) injection to the source of the original package by a Pull request/social engineering; (2) the open source project owner adding malicious functionality out of ideology, such as political; (3) injection during the build process; and (4) injection through the repositories system.

It was demonstrated that the malicious intent in packages could be categorized by several parameters: targeted Operating System (OS), PL, the actual malicious activity, the location of the malicious functionality within the package (where it is injected), and more. Additionally, they showed the majority of the maliciousness is associated with persistence purposes, which can be categorized into several major groups: Backdoors, Droppers, and Data Exfiltration.

The current application focuses on the second security issue with a specification in a dynamic PL (programming languages) (Python as a test case) for usage popularity and the popularity of injection-oriented attacks within those PLs repositories (Node.js, Python, etc.).

These injections are often related to the PLs dynamicity features, such as exposing the running functionalities only at runtime (e.g., exec(“print (Hello world!)”)), configurable dependencies and imports of packages (e.g., import from a local package instead of a global one).

The described use of the PLs dynamicity features is the most common among the known attacks. A leading example of this kind of attack included a malicious package named “pytz3-dev,” which was seen in the central repository of Python packages, the Python Package Index (PyPI), and downloaded by many. This package contains malicious code in the initialization module and searches for a Discord authentication token stored in an SQLite database. If found, the code exfiltrated the token. This attack was carried out unnoticed for seven months and downloaded by 3000 users in 3 months.

These features, and many more, are used by attackers, thus making it one of the most common attack techniques associated with a supply chain attack, as covered by NIST.

Detection methods of malicious intent in source code include static analysis and dynamic analysis. Static analysis finds irregularities in a program without executing it and is more safe than dynamic analysis.

Various detection analysis were recognized to be faulty.

Feature-based technique uses the occurrences count of known problematic functionalities. For example, this technique uses a classifier with a given labeled dataset and several features extracted (function appearances, length of the script, etc.) that can predict the maliciousness of a script. The main drawback of this technique is that it strongly binds with reversing research that points to features related to the attack, which may lead to detection overfitting the attacks that have been revealed and learned. Furthermore, potential attackers could evade detection by several methods, such as not using or not adequately using the searched features in the code. An example of such a static analysis tool is Bandit. Bandit is a widespread tool designed to find common security issues in Python files using hard-coded rules. This tool uses AST form of the source code to better examine the rule set. In addition, Bandit's detection method includes the following metrics: severity of the issues detected and the confidence of detection for a given issue. Those metrics are divided into three values: low, medium, and high. Each rule manually obtains its severity and confidence values from the Bandits' community.

Signature-based detection (in the case of malware detection) is a process where a set of rules (based on reversing procedure) define the maliciousness level of the program. Rules generated for static analysis purposes are often a set of functionalities or opcodes in a specific order to match the researched code behavior. For example, YARA is a commonly used static signature tool and the generated rules for dynamic analysis purposes are often a set of executed operations, memory states, and registers' values. The main drawback of this technique is that it applies to known maliciousness.

Comparing packages to known CVEs (see Open-source packages' security issues). On the one hand, static analysis tends to scale well over many PL classes (with a given grammar), efficiently operating on large corpora. It often identifies well-known security issues and in many cases, is explainable. On the other hand, this kind of analysis suffers from a high number of false positives and poor configuration issues detection.

Dynamic Analysis. This type of analysis finds irregularities in a program after its execution and determines its maliciousness, where gathered data, such as system calls, variable values, and IO access, are often used for anomaly detection or classification problems. There are several drawbacks to using dynamic analysis on a source code: (a) Data gathering difficulties: the procedure of extracting data is hard to automate, as the package needs to be activated and execute its functionality; and (b) Scalability: the learned and tested program must be activated in its entirety, where the wanted data has to be extracted for each. Therefore, in this study, the inventors have chosen to focus on advanced static analysis.

Deep Learning Methods for Analyzing Source Code

In recent years, there has been an increasing need to use machine learning (ML) methods in code intelligence for productivity and security improvement. As a result, many studies construct statistical models to code intelligence tasks. Recently, pre-trained models were constructed by learning from big PL corpora, such as CodeBERT and CodeX. These pre-trained models are commonly based on models from the natural language process (NLP) field (such as BERT and GPT), including improvements of the original Transformer architecture and the original self-attention mechanisms presented by Vaswani et al. Not only did this development lead not only to improvement in code understanding and generation problems, but it also to enlarged the number of tasks and their necessities, such as Clone detection and Code completion. Those tasks include several challenges, such as capturing semantic essence, syntax resemblance, and figure execution flow. For every challenge, it occurred that a model exists that would fit better than others. For example, for code translating between PLs, algorithms including a “Cross-lingual Language Model” with masked tokens preprocessing are superior for capturing the semantic essence well.

Over the years, several ML methods have been researched within the context of code analysis tasks. In 2012, the use of techniques from the classic text analysis field were shown, for example, using SVM on a bag-of-words (BOW) representation of simple tokenization (lexing by the PL grammar) of Java source. In 2016 techniques were shown to get context for the extracted tokens using, for example, the output of recurrent neural network (RNN) trained over tokenized (lexing representations) code. However, it was shown that RNN-based sequence models lack several source code concepts regarding source code representations: First, inaccurate representation of the non-sequential structure of source code. Second, RNN-based models may be inefficient for very long sequences. Third, those models lack the ability to grasp the syntactic and semantic information of the source code.

In this study, the inventors used the Code2Seq model, which is a deep neural architecture developed by Alon et al. (Uri Alon, Shaked Brody, Omer Levy, Eran Yahav, “code2seq: Generating Sequences from Structured Representations of Code”. arXiv:1808.01400), similar to Nagar et al. The inventors selected this model over others because it performs the mentioned code embedding models in a similar task, such as Code Search, and Code Captioning. Additionally, the Code2Seq model has fewer parameters compared to other models. The inventors trained the model using the PY150 dataset. This dataset contains Python functions in the form of AST (see Datasets). In this architecture, a function is referred to as an AST, where the output trees' internal nodes represent the program's construction with known rules, as described in the given grammar. The tree's leaves represent information regarding the program variables, such as names, types, and values.

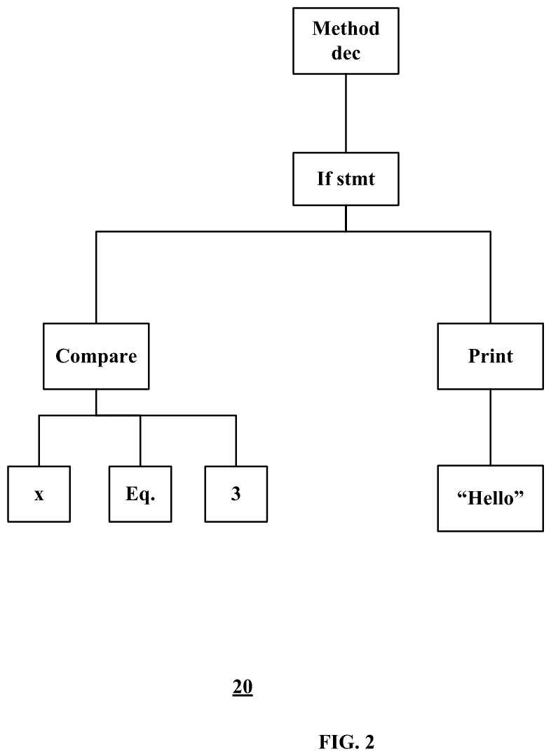

FIG. 2 outlines the notion 20 of AST on code snippets. Eventually, the Code2Seq model gets a set of AST paths, where every pairwise path between two leaf tokens is represented as a sequence containing the AST nodes. Up and down arrows connect those nodes, exemplifying the up or down link between the nodes in the tree. An example of an AST path that is shown in FIG. 2 (x, ↑if stmt, ↑method dec ↓print: “Hello”), extracted from code snippets as input. Then, a bi-directional LSTM encodes those paths, creating a separate vector representation for each path and its AST values. Next, the decoder attends to the encoded paths while generating the target sequence. The final output of the Code2Seq model generates a sequence of words that explain the functionality of the given code snippet. For example, with a source code function of calculation power of two of a given variable that inputted to the Code2Seq model, the result was in an output word sequence of “Get Power Of Two.”

Code2seq can be integrated into many applications, such as code search: with a given sentence describing a code, and the output will be the wanted code. For example, Nagar et al. used the Code2seq model to generate comments for collected code snippets. The candidate code snippets and corresponding machine-generated comments were stored in a database where eventually, the code snippets with similar comments to natural language queries were retrieved.

Results

This section presents the experimental results obtained by the MSDT algorithm (see The proposed method section) when applied to the constructed function types dataset that contained both injected and benign implementations (see Injection simulation section). It is worth noting that this study used 8 GB RAM with 8 CPU cores server to evaluate the algorithm. The runtime of the process took about 10 minutes for 48627 different implementations.

The constructed dataset includes the 100 most common function types from the CSN dataset (see Datasets section). From the function types implementations distribution (see FIG. 2), the most common function type is the get function with over 3,000 unique implementations, and the least common of those function types is the prepare with 102 unique implementations.

The first experiment included parameter tuning of the DBSCAN method mentioned in the Anomaly detection on representation section, which the inventors applied to the CSN dataset without the 100 most common function types.

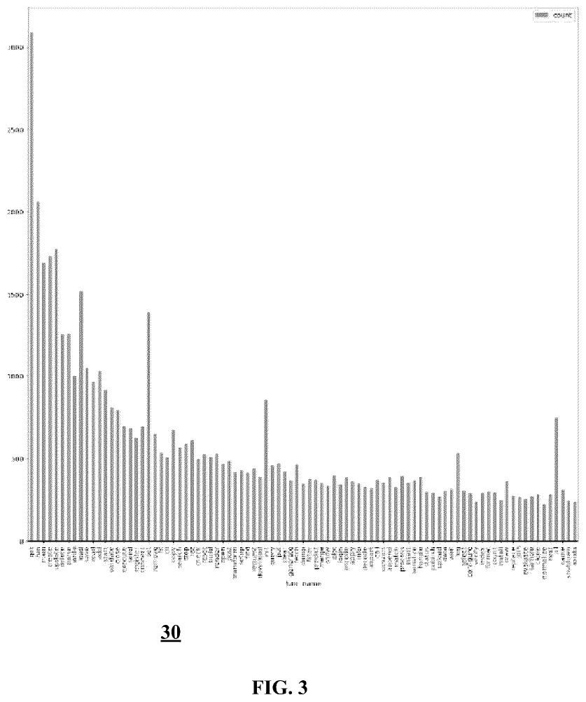

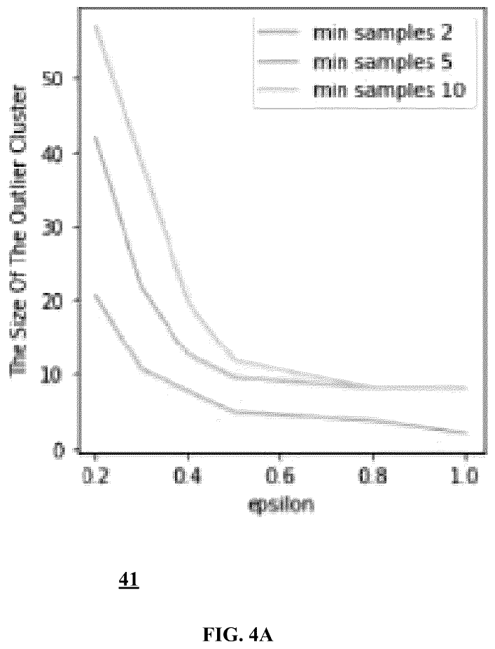

Inventors received the following best results 30 (see FIG. 3) for eps=0.3 and min samples=10: TPR=0.637, AP=0.384 and outlier detection precision=0.953. These results indicate that it is possible to detect anomalies by finding outliers with probable rates. Furthermore, when the default values of the DBSCAN method were set, it obtained TPR=AP=0.373, and outlier detection precision=0.738. Therefore, the DBSCAN with the tuned parameters exceeded the one with the default parameters.

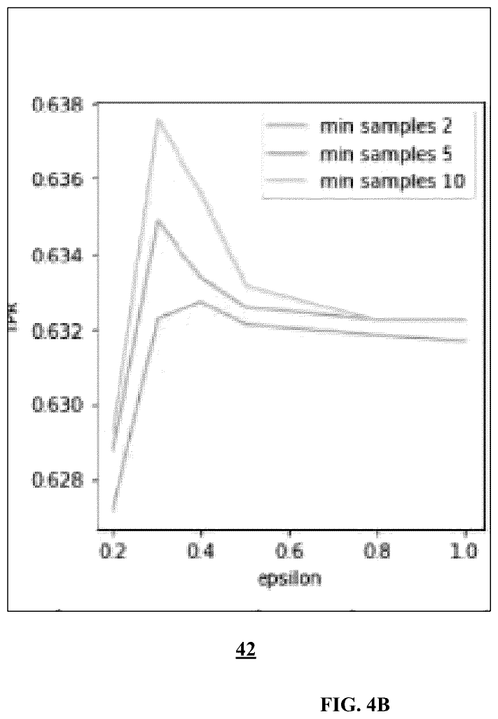

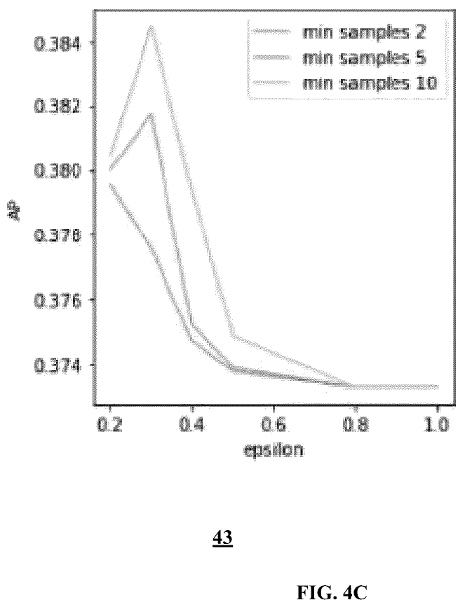

The second experiment included the evaluation of MSDT_{DBSCAN} on every function type against every attack type and every k in the range of 1 to 10 percent of the implementations. For every iteration of k, the inventors measured precision @ k. the inventors found that MSDT_{DBSCAN} detects well when applied to several functions and attacks. See examples 41, 42 and 43 of FIGS. 4A, 4B and 4C, of the get function with three of the mentioned attacks, for k=MSDT presented the highest value of precision @ 10=0.909, compared to precision@ 10=0, which the Random Classifier obtained. On the other hand, the inventors found that MSDT_{DBSCAN} achieved less successful results on several functions, no matter the type of the applied attack and the value of the k, such as the log function with all the attacks, specifically the non-obfuscated attack. Table 1 presents in detail the results of these experiments, where the Average Precision (AP) of these experiments are shown to demonstrate the complete picture of the classification's nature.

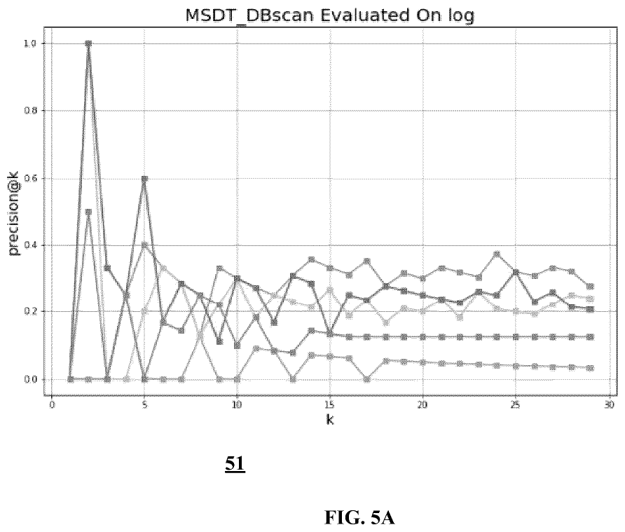

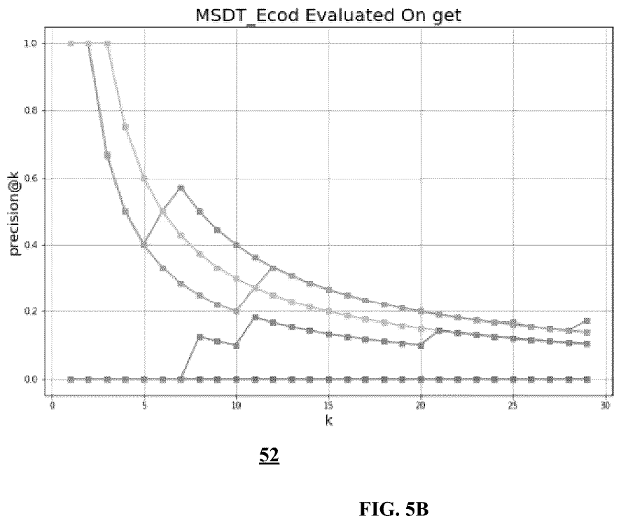

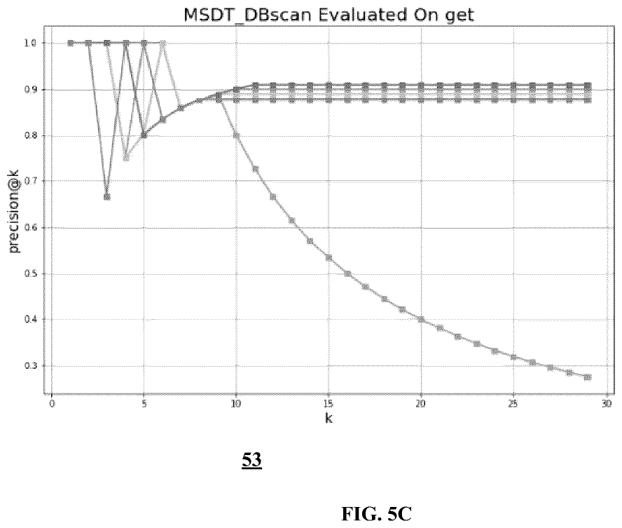

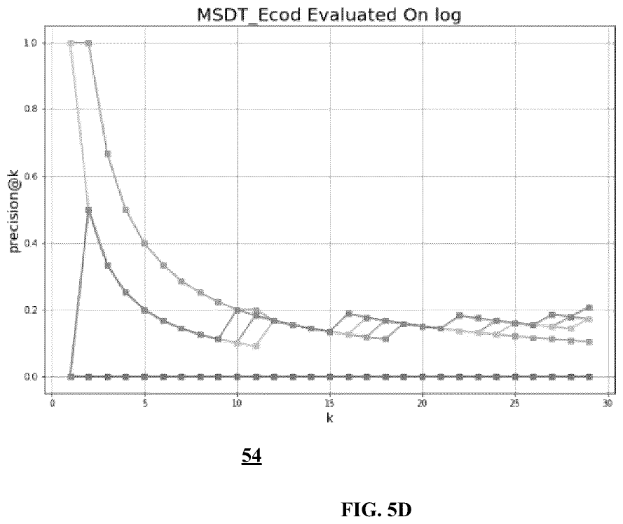

In addition, the inventors discovered that the measured Spearman's rank correlation between the MSDT'S detection rate and the number of implementations is equal to p=0.539, indicating a correlation between the detection rate and the number of implementations. the inventors also tested the MSDT_{Ecod} on the same experimental settings described in the Code2seq representation section. Following the mentioned evaluation (see the Evaluation Process section), the inventors measured the precision@ k for every k ranging from 1 to 30. the inventors can observe that generally, the MSDT_{Ecod} detects the top two rank anomalies and is less successful in the following k values (see examples 51, 52 and 53 of FIGS. 5A, 5B and 5C). Table 1 illustrates precision@ k for three functions with all attacks and k values.

TABLE 1

| | | | | | | Loading a | |
|---|---|---|---|---|---|---|---|
| | | | Execution | Execution | Execution | file from | Payload |
| | | | of an | of anon- | of an | the root | construction |
| | | | obfuscated | obfuscated | obfuscated | directory | as an |
| | Function | | string | script | string using | of the | obfuscation |
| model | Name | k | using exec | using exec | os.system | program | use case |
| MSDT_{DBSCAN} | get | 10 | 0.9 | 0.8 | 0.889 | 0.9 | 0.7 |
| | | 20 | 0.9 | 0.4 | 0.889 | 0.909 | 0.35 |
| | | 30 | 0.9 | 0.267 | 0.889 | 0.909 | 0.233 |
| | log | 10 | 0.4 | 0.1 | 0.4 | 0.3 | 0.3 |
| | | 20 | 0.15 | 0.05 | 0.25 | 0.25 | 0.2 |
| | | 30 | 0.3 | 0.033 | 0.267 | 0.233 | 0.267 |
| | update | 10 | 0.7 | 0.167 | 0.7 | 0.7 | 0.6 |
| | | 20 | 0.733 | 0.167 | 0.722 | 0.75 | 0.706 |
| | | 30 | 0.733 | 0.167 | 0.722 | 0.821 | 0.706 |
| MSDT_{Ecod} | get | 10 | 0.5 | 0.4 | 0.3 | 0.1 | 0.2 |
| | | 20 | 0.3 | 0.25 | 0.15 | 0.05 | 0.1 |
| | | 30 | 0.276 | 0.172 | 0.138 | 0.034 | 0.103 |
| | log | 10 | 0.3 | 0.1 | 0.1 | 0.2 | 0.2 |
| | | 20 | 0.15 | 0.15 | 0.1 | 0.1 | 0.2 |
| | | 30 | 0.172 | 0.103 | 0.103 | 0.069 | 0.172 |
| | update | 10 | 0.2 | 0.5 | 0.4 | 0.1 | 0.2 |
| | | 20 | 0.2 | 0.35 | 0.35 | 0.05 | 0.2 |
| | | 30 | 0.172 | 0.276 | 0.276 | 0.038 | 0.241 |

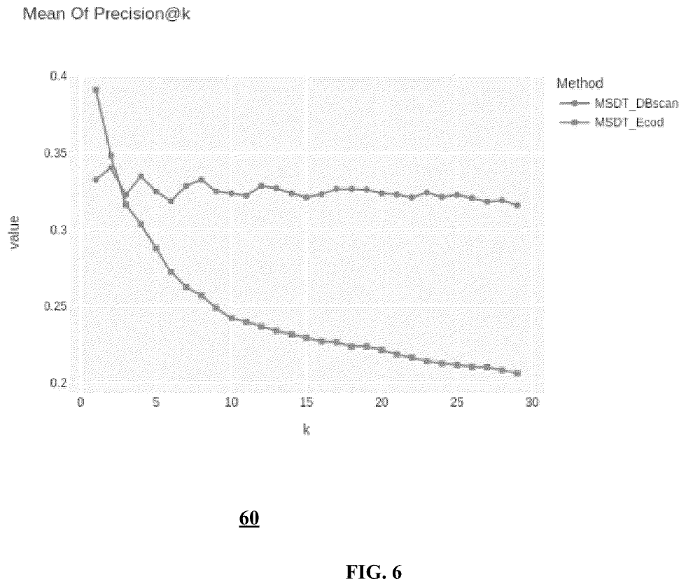

The third experiment included detecting injected malicious implementations of multiply by applying MSDT_{DBSCAN}. By visualizing the PCA (2 components) of the collected samples (see example 60 of FIG. 6), the inventors can see that detecting the attacked functions, in this case, is a complex task. Additionally, the inventors can see (see FIG. 6) that by applying MSDT_{DBSCAN}, the inventors managed to detect the malicious implementation, along with two unique and odd implementations. Those implementations include: (1) adding in a for loop the first input number by the second input number; and (2) output the result by comparing the two input numbers to a results dictionary. Then the inventors compared the results of this experiment to Bandit and Snyk, yielding that the static analysis tools failed to detect these attacks. Additionally, the inventors compared MSDT_{DBSCAN} to MSDT_{Ecod}, which detects only one of the mentioned unique implementations.

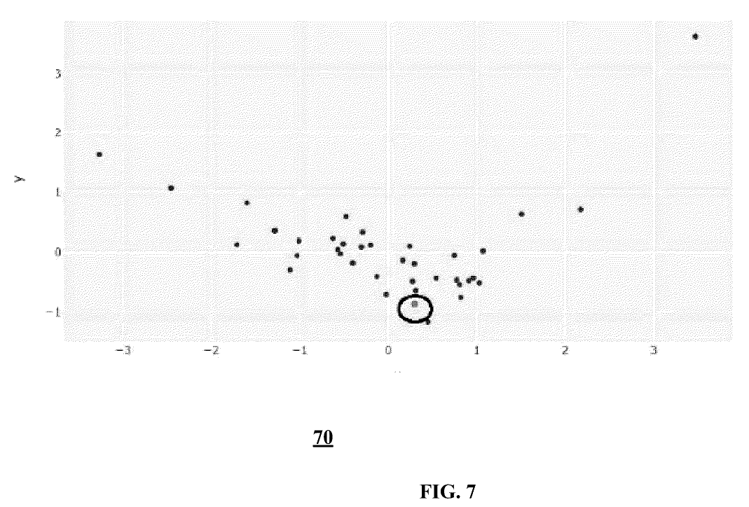

The fourth experiment emphasizes the relations between malicious and benign implementations. By the following visualization, the inventors received (see example 70 of FIG. 7) that the get functions tend to cluster, while log functions do not cluster well. Therefore, this illustrates the differences in the distribution of the various function types.

### Discussion

Based on theirs analysis of the results presented in the Results section and the figures above, the inventors can observe the following:
a. First, MSDT_{DBSCAN}, which detects malicious code injections to functions by anomaly detection on an embedding layer, had promising results when evaluated on different function types with various injected attacks, reaching to precision@ k up to 0.909 with median=0.889 and mean=0.807 for get and list function types (see FIGS. 4A, 4B, 4C and 4D).
b. Second, MSDT_{DBSCAN} succeeded compared to other tools and methods (see Table 1 and FIGS. 5A, 5B and 5C). For example, the general precision@ k of MSDT_{DBSCAN} is higher for k>2 compared to the MSDT_{Ecod}-based method). As mentioned in the Injection simulation section, the simulated injections are taken from real-world cases and injected into functions. To illustrate real-world code injection detection, the inventors conducted an empirical experiment, which includes detecting real-world attacks by MSDT_{DBSCAN}. MSDT_{DBSCAN} results seem promising compared to other widely used static analysis tools and MSDT_{Ecod}, in this specific case (see example 60 of FIG. 6). The MSDT_{DBSCAN} is also applicable on other real-world cases and tests on different program language functions. It is also worth noting that the mentioned static analysis tools can only work on files, while MSDT works on functions. While this gives a more precise ability to detect code injections in functions, when applied to rare functions without many implementations, the MSDT can be used on similar functions to help to detect code injection in rare functions.
c. Third, the inventors observed similar results when MSDT_{DBSCAN} evaluated similar attacks. For example, the attacks that utilized exec and os.system (as seen in get results in FIG. 4) using the same payload but different execution functions. Additionally, the inventors can see that the precision@ k values are relatively similar for these two attacks in general. This conclusion shows us that if MSDT_{DBSCAN} manages to detect some attack well, it should detect another semantically related attack, the inventors found that MSDT_{DBSCAN} seems to succeeds when applied to functions with specific functionality that repeats in the various implementations of the same function type. For example, the update implementations tend to be similar—in general, this type of function gets an object and calculates or gets as an input a new value to insert in the given object—as can be seen for functions like list and update are with the main functionality and a relatively high precision@ k. In this case, the various implementations of the same function type are semantically similar, yielding that the embedding for each is close, and hence cluster well (see example 70 of FIG. 7).
d. Fifth, the inventors found that MSDT_{DBSCAN} 's detection rate positively correlates to the number of implementations in the function type. Hence, MSDT_{DBSCAN} is more likely to achieve a higher detection rate with a more common function type with numerous implementations.
e. Sixth, when injecting attacks with extensive line lengths, such as the non-obfuscated script execution, MSDT_{DBSCAN} tends to achieve less successful results (see FIGS. 4A-4D). For example, when evaluating MSDT_{DBSCAN} on the different function types injected with the non-obfuscated script, the inventors generally get a low precision@k. In this case, the injected functionality is a script with numerous lines, which probably affects the Code2Seq robustness and causes it to miss-infer the function's functionality. According to an embodiment, the Code2Seq and a more robust model for source code (such as Seq2Seq) are used stacking model to overcome Code2Seq vulnerabilities.
f. Seventh, the inventors can observe that MSDT_{DBSCAN} tended to achieve less successful results when applied to abstract functions with functionality that does not repeat in other implementations for functions like run, configure, etc. For example, the install function generally is supposed to change the state of the endpoint by activities that belong to the installation process (each application has a different process), such as writing files to disk or establishing a connection with a remote server, etc. Each application has a different process with its unique activities to install the app. In this case, the various implementations of the same function type are inherently different, yielding that the embedding for each of those is not close and therefore does not cluster well (see FIG. 7 for illustration). However, the inventors can detect anomalies with MSDT_{DBSCAN} with given versions of the abstract function.
g. Eighth, the inventors managed to cluster functions by the similarity of their functionalities, i.e., even though various implementations were written, the inventors could perform work related to similarities, such as cluster and outlier detection. This similarity propriety is achieved by using Code2Seq for embedding, which identifies the functionality of the function (see The proposed method section). Different similarity methods that rely on tokens, N-grams, and strings similarities could damage the mentioned similarity property, as it does not extract the semantic information of the function, but the structural information.
h. Finally, as can be observed from the results, statically detecting code injection within functions is a challenging and not homogeneous task for all of the various cases, such as function and attack types. However, MSDT had shown successful results for some cases simulated in the experiments. Therefore, MSDT can be used as a detection tool that indicates what function needs further investigation and thus reduces the search space and allows for the prioritization of anomalies.

This study introduces MSDT, a novel algorithm to statically detect code injection in functions' source code by utilizing a deep neural translation model named Code2Seq and applying anomaly detection techniques on Code2Seq's representation for each function type. the inventors comprehensively described MSDT's steps, starting with collecting and preprocessing a dataset. After injecting five malicious functionalities into random implementations, the inventors extracted embedding for each implementation in the function type. Based on these embeddings, the inventors applied an anomaly detection technique, resulting in anomalies that the inventors eventually ranked by their distance from the nearest cluster border point.

This evaluation of MSDT on the constructed dataset demonstrates that MSDT succeeded for cases when: (1) the functions have a repetitive functionality; and (2) the injected code has a limited number of lines. However, MSDT was less successful when: (1) the injected code contains a relatively large number of lines; and (2) the functions have a more abstract functionality.

For the MSDT to use the Code2Seq embedding, it is necessary to convert every function to an AST representation. According to an embodiment a more comprehensive representation is used for a code that includes the semantic, syntactic, and execution flow data of the program—for instance, using execution paths in a control flow graph that have been constructed statically from a program, or using program dependence graph (PDG).

According to an embodiment, the enable MSDT is configured to support any textual PL. This can be done using the proper grammar and a deep neural architecture (Code2Seq) to embed functions' source code.

According to an embodiment, models other than Code2Seq are used for source code embeddings, like Seq2Seq, CodeBERT, and CodeX.

According to an embodiment, other outlier detection models are used on this high-dimension clustering problem.

### An Example of a Method

The primary goal of this study is to detect code injection by applying static analysis to the source code. This section describes the static analysis algorithm the inventors developed and theirs experiments to test and evaluate theirs proposed method, MSDT (see the Experiments section).
a. As presented in the Open-source packages' security issues section, in supply chain attacks, the injected functionality will often be added to the source of the targeted program. Therefore, the code will be changed. This study presents MSDT, an algorithm to detect the mentioned difference in the program's functionality for a chosen PL, by the four following steps (see example 10 of FIG. 1):
   i. Data collection. In this step, the inventors collect sufficient function implementations of the chosen PL, for each function type. For example, to detect code injection in the “encode” function, the inventors collect a sufficient amount of “encode” implementations to better estimate the distribution of the implementations. In addition, the collected data can be different versions of the same function. The collection of data can be manually collected from any code-base warehouse (such as GitHub) or extracted from an existing code dataset: for example, an existing dataset of functions with their names and implementations (see Datasets section).
   ii. Code embedding. In this step, the inventors create an embedding layer to the given source code snippets using an algorithm that gets sequence data and represents it as a vector. Examples of such algorithms are neural translation models (NMT) and transformers that vectorize the input sequence and transform it to another sequence, such as Seq2seq, Code2seq, CodeBERT, and TransCoder. The resulting embedding layer has to be reasonable so that similarity in the source code snippets (similar functions) translates to a similarity in the embedding space. For example, the vectors of the square-root and cube-root functions will be relatively close to each other and farther than the parse timezone function's vector. As mentioned in the Deep learning methods for analyzing source code section, the inventors used Code2Seq embeddings vectors. The inventors used Alon et al. implementation for the Code2Seq model and set it with the same parameters, which yields best results after experiments conducted in the Code2Seq study. the inventors trained the Code2Seq model on a server with a high RAM setting. The server specifications include 256 GB RAM and 48 Intel 6342 2.8 GHz CPU cores. The training process continued for 24 hours on 130 K functions. the inventors compared these results with an additional server, including 96 GB RAM and two NVIDIA Tesla V100. In this case, the training process continued for 12 hours on 130 K functions. the inventors construct the encoder to be two bi-directional LSTMs that encode the AST paths consisting of 128 units each, and the inventors set a dropout of 0.5 on each LSTM. Then, the inventors construct the decoder to be an LSTM consisting of one layer with size 320, and the inventors set a dropout of 0.75 to support the generation of longer target sequences.
   iii. Anomaly detection. In this step, the inventors apply an anomaly detection technique by applying cluster algorithms and detecting the outliers. For example, the inventors can utilize DB SCAN and K-means to cluster the input and detect outliers. 85 the inventors use this technique on every function type embedding layer and manage to differentiate code snippets that were injected from benign code snippets.
   iv. Anomaly ranking. Lastly, the inventors rank the outliers by their distance from the nearest clusters' border points in this step. The farther the point is, the higher the score.

### Experiments

There are several datasets including labeled function implementations for several purposes. In this study, the inventors used 607,461 public Python function implementations with simulated test cases and real-world, observed attacks. Additionally, this study combines an embedding layer based on a deep neural translation model, Code2Seq. Lastly, this study showcases traditional anomaly detection techniques over the Code2Seq representation based on DB SCAN compared to another anomaly detection technique based on Ecod.

Datasets

In this study, the inventors utilized three datasets: (1) the Eth PY150 dataset is used for training Code2Seq as for the presented model of Code2Seq is trained upon Java dataset. The Eth PY150 is a Python corpus with 150,000 files. Each file contains up to 30,000 AST nodes from open-source projects with non-viral licenses such as MIT. For the training procedure, the inventors randomly sampled the PY150 dataset to validate/test/train sets of 10 K/20 K/120 K files; (2) the CodeSearchNet (CSN) Python dataset is used to perform the different experiments to prevent data leakage from the training procedure, where CSN is a Python corpus, containing 457,461<docstring, code>pairs from open source libraries, which the inventors refer only to as the code; and (3) the Backstabber's Knife Collection is used for the malicious functionalities injected during the simulations. The Backstabber's Knife Collection is a dataset of manual analysis of malicious code from 174 packages that were used by real-world attackers. Namely, the inventors use five different malicious code injections from this collection, to inject in the 100 most common functions within the CSN corpus. the inventors chose those specific malicious codes for their straightforward integration within the injected function, and their download popularity.

As mentioned above, the input to the Code2seq model is an AST representation of a function. To get this representation for each function, the inventors extracted tokens using fissix and tree sitter, which allowed us to normalize the code to get consistent encoding. With the normalized output code, the inventors then generate an AST using fissix.

Injection Simulation

The inventors randomly selected up to 10% implementations from each of the top 100 common functions to be code injected to simulate the real-world number of code injections. To find the 100 most common functions, the inventors count the number of implementations for each function in the CSN dataset and refer to the 100 most frequent functions. The total number of the 100 most common function implementations was 48627. The injected functionalities were five malicious samples collected from Backstabber's Knife Collection.

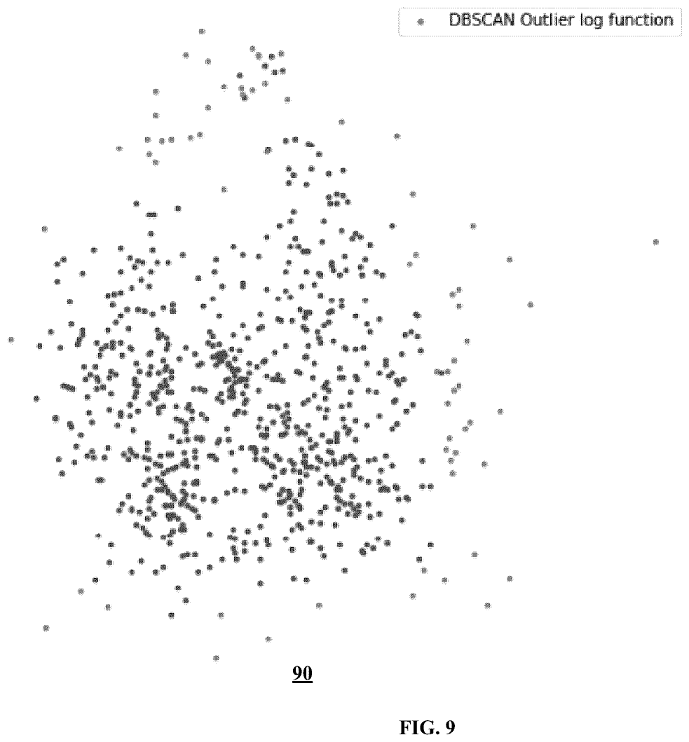

Those injections illustrated several attack types:
a. A one-liner execution of obfuscated string, encoded by base64. This string is a script that finds the Discord chat application's data folder on Windows machines and then attempts to extract the Discord token from an SQLite database file. Once found, the Discord token is found, it is sent to a web server. In this study, the inventors used two different execution functions (in different types of injections): exec and os.system functions. These functions allow the user to execute a string.
b. A one-liner execution of non-obfuscated script: the deobfuscation of the described above attack.
c. Loading a file from the root directory of the program. The loaded file is a keylogger that eventually sends the collected data to a remote server via email. To mask the keylogger loading, the inventors used the Popen function to execute the malicious functionality in other subprocesses (see FIG. 9).
d. Attacker payload construction as an obfuscation use case. the inventors split the obfuscated string (the first attack mentioned in this section) into several substrings. Then, the inventors concatenate those strings in several parts of the program to construct the original attacker string and execute the concatenate string using os.system function.

The functionalities were injected at the beginning of the randomly selected implementations for those popular function types, and as viewed by Ohm et al., and similar to the mentioned attacks above.

Code2seq Representation

In this study, the inventors used the result vectors of the attention procedure (see Deep learning methods for analyzing source code section), named context vectors with 320 dimensions; it was the representation space of the model for code snippets. At each decoding step, the probability of the next target token depended on the previous tokens.

The inventors used the same parameters presented by Alon et al. Additionally, the inventors trained the model on the Eth PY150 train set (as mentioned in Datasets section) for 20 epochs or until there was no improvement after ten iterations. Eventually, the inventors tested theirs Code2seq model on the Eth PY150 test set (as mentioned in the Datasets section) and achieved a recall of 47%, precision of 64%, and F1 of 54% on the mentioned randomly sampled test set.

Anomaly Detection on Representation

In this step, the inventors used their Code2Seq representation (see the Code2seq representation section) for the given injected functions and non-injected from the same type. Then, the inventors used the DBSCAN method (referred to as MSDT_{DBSCAN}) as the density-based clustering algorithms are known to perform better in finding outliers. the inventors achieved it by using tuning the following parameters for the DB SCAN method:
a. eps specifies the distance between two points and whereas tests were conducted with the following values: 0.2-1.0.
b. min samples specify the minimum number of neighbors to consider a point in a cluster, whereas tests were conducted with the following values: 2-10.

For each iteration, a 10-fold cross-validation is applied, measuring the following metrics by the means of the different folds (TPR and AP), detecting outlier precision.

Evaluation Process

The performance of the anomalies detected by MSDT was measured by precision at k (precision@k) study, which stands for the true positive rate (TPR) of the results that occurs within the top k of the ranking. the inventors ranked the anomalies by their Euclidean distance from the nearest clusters' border points. Eventually, the inventors measured the precision@k metric for each function type with the mentioned code injection attacks and compared it to a RandomClassifier, to show the performance of MSDT relative to a random decision, as there are no other methods that work on functions use for comparison (see the Introduction and Background sections). To better understand how MSDT detects attacks, the inventors examined the correlation between the detection rate and the number of implementations among the various function types. Therefore, the inventors measured the average precision@k for every attack, and for every function type, the inventors calculated the average of the average detection rate of the various attacks. the inventors used Spearman's rank correlation (ρ) to measure the correlation between the mentioned average of the function types and their number of implementations.

The inventors compared MSDT_{DBSCAN} 's performance to another outlier detection baseline method named Ecod (referred to as MSDT_{Ecod}) over the mentioned representation (see the Anomaly detection on representation section). The inventors chose Ecod because it outperformed several widely used outlier detection, such as KNN. The inventors used Ecod to detect outliers as follows: firstly, the inventors applied Ecod on every function type for every attack type (accordingly to MSDT_{DBSCAN}). Secondly, the inventors measured the anomaly score of each implementation. The Ecod algorithm calculates this score, where the more the vector is distant, the higher its score. Thirdly, the inventors extracted the precision@k where k indicates the anomalies in descending order, i.e., precision@2 is the precision of the two most highly ranked anomalies.

To evaluate their method on real-world injections, the inventors applied MSDT_{DBSCAN} on a real-world case taken from the Backstabber' s Knife Collection. The case was a sample of malicious functionality injected in multiply calculation functionality that loaded a file by Popen, as mentioned above in Injection simulation. the inventors collected 48 implementations of multiply related functions from the mentioned datasets (see Datasets section). the inventors did so to gain reference of the injected multiply function to the benign implementations and thus applied MSDT_{DBSCAN} on this multiply case.

Additionally, the inventors compared MSDT with the mentioned MSDT_{Ecod} method and two of the well-known static analysis tools named Bandit and Snyk (see the Static Analysis section). Namely, the inventors evaluated those static analysis tools on the origin file where the malicious implementation of multiply appeared.

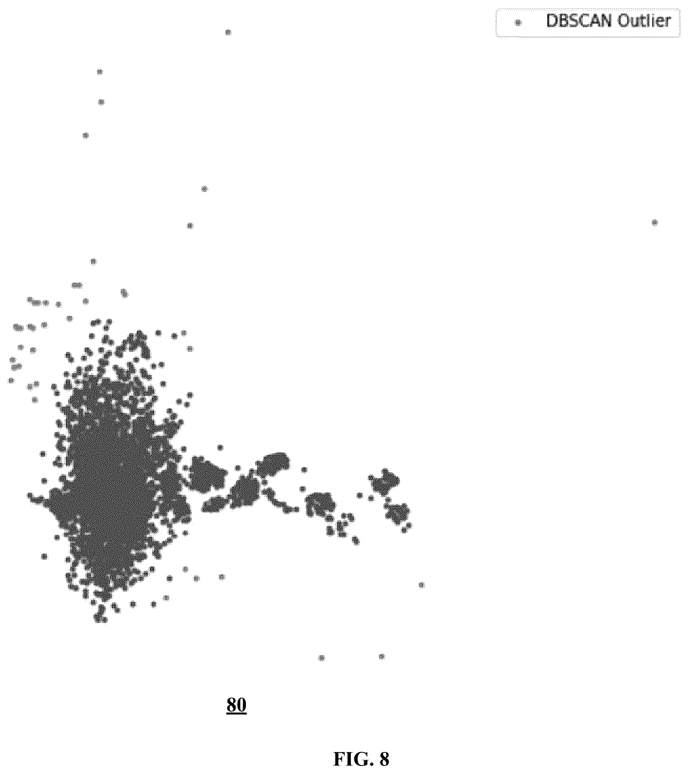

Lastly, to emphasize the relations between the malicious and the benign implementations, the inventors visualized the achieved embedding of the get and the log functions with the injected code. the inventors managed this visualization by applying PCA (2 components) on the Code2Seq context vectors (see Code2seq representation section). See examples 80 and 90 of FIGS. 8 and 9, respectively.

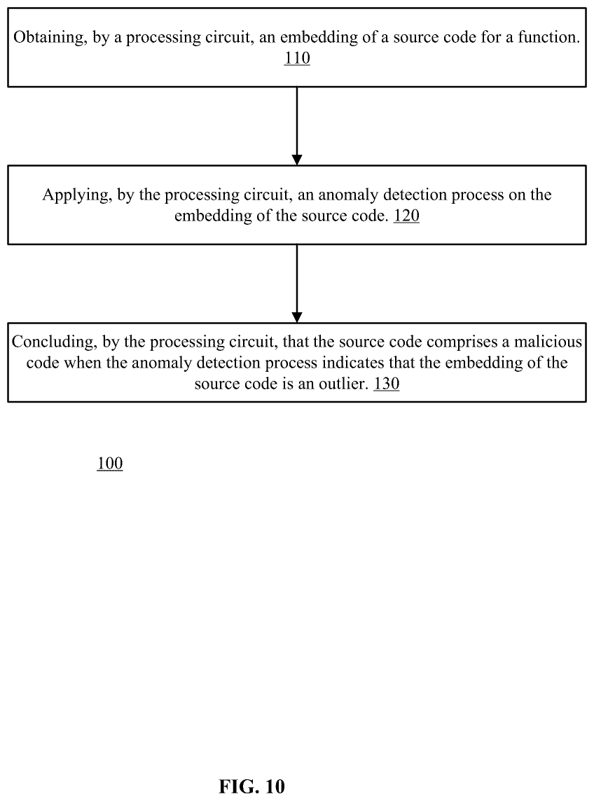

FIG. 10 illustrates an example of method 100 for malicious source code detection.

Method 100 may be executed by a processing circuit or more than a single processing circuit.

The processing circuit may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

According to an embodiment, method 100 is applied on a source code for a function. The source code may be of any size.

According to an embodiment, method 100 includes step 110 of obtaining, by a processing circuit, an embedding of a source code for a function. The obtaining may include at least one of generating the embedding or receiving the embedding.

According to an embodiment, step 110 includes calculating the embedding or receiving the embedding.

An embedding may be generated in different manners—for example by different deep learning models. The calculating of the embedding may include selecting a deep learning model out of multiple deep learning models. The selected deep model is applied on the source code in step 120.

The selection may be based on at least one of a length of the source code, available computational resources, available memory resources, and the like.

We claim:

1. A method for malicious source code detection, the method comprising:
(a) obtaining, by a processing circuit, an embedding of a source code for a function;
(b) applying, by the processing circuit, an anomaly detection process on the embedding of the source code; and
(c) concluding, by the processing circuit, that the source code comprises a malicious code when the anomaly detection process indicates that the embedding of the source code is an outlier.

2. The method according to claim 1, wherein the embedding is generated by a deep learning model.

3. The method according to claim 1, wherein the applying of the anomaly detection process comprises matching the embedding of the source code to clusters of embeddings of functions.

4. The method according to claim 3, wherein at least one cluster of the clusters comprises embeddings of different training source codes for different functions.

5. The method according to claim 3, wherein the applying of the anomaly detection process comprises calculating distances between the embedding of the source code and centroids of the clusters.

6. The method according to claim 3, wherein the applying of the anomaly detection process comprises calculating an anomaly score of the source code based on a distance between the embedding of the source code and a closets cluster of the clusters.

7. The method according to claim 3, comprising:
repeating steps (a), (b) and (c) for different source codes for different functions; and ranking the different source codes based on distances between each source code and a centroid of a closest cluster of the clusters.

8. The method according to claim 1, wherein the obtaining of the source code comprises analyzing an evaluated source code.

9. The method according to claim 1, comprising repeating steps (a), (b) and (c) for different source codes for different functions.

10. The method according to claim 1, comprising repeating steps (a), (b) and (c) for different source code versions for a single function.

11. The method according to claim 1 wherein the obtaining of the embedding of the source code comprises calculating the embedding.

12. The method according to claim 10, comprising selecting a deep learning model out of multiple deep learning models; and wherein the calculating of the embedding comprises applying the selected deep model on the source code.

13. The method according to claim 11, wherein the selecting is based on a length of the source code.

14. The method according to claim 10, wherein the calculating of the embedding comprises representing the source code as one or more abstract syntax trees (ASTs).

15. The method according to claim 10, wherein the calculating of the embedding comprises using a code to sequence conversion.

16. A non-transitory computer readable medium for malicious source code detection, non-transitory computer readable medium stores instruction that once executed by a processing circuit cause the processing circuit to:
(a) obtain an embedding of a source code for a function;
(b) apply an anomaly detection process on the embedding of the source code; and
(c) conclude that the source code comprises a malicious code when the anomaly detection process indicates that the embedding of the source code is an outlier.

17. The non-transitory computer readable medium according to claim 16, wherein the applying of the anomaly detection process comprises matching the embedding of the source code to clusters of embeddings of functions.

18. The non-transitory computer readable medium according to claim 17, that stores instructions for repeating steps (a), (b) and (c) for different source codes for different functions; and ranking the different source codes based on distances between each source code and a centroid of a closest cluster of the clusters

19. The non-transitory computer readable medium according to claim 17, wherein the obtaining of the embedding of the source code comprises calculating the embedding, wherein the calculating of the embedding comprises selecting a deep learning model out of multiple deep learning models; and wherein the calculating of the embedding comprises applying the selected deep model on the source code.

20. The non-transitory computer readable medium according to claim 19, wherein the selecting is based on a length of the source code.
